(19) United States
(12) Patent Application Publication
(10) Pub. No.: US 2018/0060951 A1
(43) Pub. Date: Mar. 1, 2018

(54) BOOK SAVIOR MOBILE APPLICATION SYSTEMS

(71) Applicant: Beatrice Marie Anderson, Chandler, AZ (US)

(72) Inventor: Beatrice Marie Anderson, Chandler, AZ (US)

(21) Appl. No.: 15/683,314

(22) Filed: Aug. 22, 2017

Related U.S. Application Data
(60) Provisional application No. 62/378,387, filed on Aug. 23, 2016.

(51) Int. Cl. G06Q 30/06

(52) U.S. Cl. CPC G06Q 30/0645

(57) ABSTRACT

A book savior mobile application system and method is a mobile application program useful for creating a mobile device network for purposes of lending and renting books. The network allows users to register accounts to rent textbook copies for a desired period of time at a reasonable cost by finding lenders willing to rent or sell a book. The application program includes a search function utilizing parameters such as book information, course textbook lists, and lender locations. Course professors may utilize the app to provide their students with a required material list for local courses to be viewed through the app network. Additional functionalities including screenshot and note storage, personal messaging, profile customization, user rating, barcode scanning, and audiobook conversion may be included.

### CROSS REFERENCE TO RELATED APPLICATION

The present application is related to and claims priority to U.S. Provisional Patent Application No. 62/378,387 filed Aug. 23, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of mobile applications and more specifically relates to a mobile application for facilitating access to books.

### 2. Description of Related Art

A mobile application (frequently referred to as a “mobile app”) is a software application designed to run on mobile devices such as smartphones and tablet computers. The term “app” is a shortening of the term “application software”. Most mobile devices are sold with several apps bundled as pre-installed software, such as a web browser, email client, calendar, mapping program, and an app for buying music or other media or more apps. Additional apps from external sources with compatible software may be installed on such devices as well. Usage of mobile apps has become increasingly prevalent across mobile phone users.

Mobile apps were originally offered for general productivity and information retrieval, including email, calendar, contacts, stock market and weather information. Many apps now allow mobile devices to access a specific online social networking service. A social networking service is a platform to build social networks or social relations among people who share similar personal and career interests, activities, backgrounds or real-life connections. Certain social network services may also connect users for financial transactions.

With an increase in attendance at institutions of higher learning, the cost of textbooks and other educational materials has risen considerably. In some cases, textbooks for some courses may also be difficult to find. Many students at such institutions encounter difficulty in sourcing affordable materials for their courses, despite the increased accessibility to various networks available through mobile devices. A suitable solution is desired.

U.S. Pub. No. 2002/0077925 to Mikio Fujita relates to a buying and selling system of secondhand books using the network of convenience stores. The described buying and selling system of secondhand books using the network of convenience stores includes a business system that the trader buys secondhand books and sells them again using the network of convenience stores. The trader establishes the main server on internet and also opens the homepage on the website. The trader makes contracts concerning buying and hand-over business of secondhand books with convenience stores. This system features that the payment of the second hand book is accepted at the convenient store or card payment is available for the order on website.

### BRIEF SUMMARY OF THE INVENTION

In view of the foregoing disadvantages inherent in the known mobile applications art, the present disclosure provides a novel book savior mobile application system and method. The general purpose of the present disclosure, which will be described subsequently in greater detail, is to provide a mobile application program useful for creating a mobile device network for purposes of lending and renting physical textbooks and providing means for scheduling face-to-face meeting for exchanging such books.

A book savior mobile application system and method is disclosed herein. The book savior mobile application system includes mobile-application supporting a software of the book savior mobile application system and a mobile device in communication with the mobile-application. The mobile device includes a display, a memory and a processor in functional combination. The book savior mobile application system provides means for a book exchange including at least one user to buy, lend, and sell used-books. The mobile-application is supported on the mobile device.

Book savior mobile application system may essentially comprise a software application which connects textbook lenders and lendees in a social network and simplifies the process of sourcing course materials. The network may be installed to commercially available mobile devices, and may be accessed virtually anywhere that internet connectivity is established. The application program may allow a plurality of users to find desired textbooks using an integrated search function, capable of finding physical textbooks available for purchase or lease.

The network may optionally be used to connect users in a specified locality, which may be useful for lending physical materials between users within a certain geographic location. Once a user finds a desired textbook, a lease period may be specified and a secure payment may be made instantly using a checkout function of the mobile application software.

Users searching for materials may use the mobile application software's search function to locate textbooks based on a variety of parameters, including book title, author, ISBN, and approved course lists.

One novelty of the present invention is the capability for lendees to rent a text for a user-specified lease period and material portion. A minimum lease period may be set to 24 hours, for example, but a user may choose to rent a physical textbook for any number of days, paying a proportional lease fee accordingly. Lendees may view a timer showing the remaining time for each lease.

Preferably, initial user registration may be achieved using merely a student ID number and a credit or debit card number. Once a user logs in using their school email or ID, they are automatically synced with their course lists. Required textbooks, syllabi, and other information listed by professors may be accessed.

The homepage of the mobile application software may provide access to each of the above features. A user may additionally edit their profile, save and review notifications or notes, view past financial transactions and proceed totals. Once logged in, the user may view options to make payments and listen to audiobooks.

A method of using book savior mobile application system and method is also disclosed herein. The method of using book savior mobile application system and method may comprise the steps of: a user accessing a book savior mobile application on a mobile device; registering as the user; searching for a used-book in a specified area; negotiating with a lender of the used-book; the lender receiving a request to purchase the used-book; the lender accepting an offer from the user; the user making a payment; the lender receiving payment; and the lender delivering the used-book.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a book savior mobile application systems and method, constructed and operative according to the teachings of the present disclosure.

FIG. 1 is a flowchart illustrating the book savior mobile application system and method according to an embodiment of the disclosure.

FIG. 2 is a diagram the book savior mobile application system and method of FIG. 1, during an ‘in-use’ condition, according to an embodiment of the disclosure.

FIG. 3 is a screen view the book savior mobile application system of FIG. 1, according to an embodiment of the present disclosure.

FIG. 4 is a screen view the book savior mobile application system of FIG. 1, according to an embodiment of the present disclosure.

FIG. 5 is a flow diagram illustrating a method of use for book savior mobile application system and method, according to an embodiment of the present disclosure.

FIG. 6 is a screen view the book savior mobile application system of FIG. 1, according to an embodiment of the present disclosure.

FIG. 7 is a screen view the book savior mobile application system of FIG. 1, according to an embodiment of the present disclosure.

FIG. 8 is a screen view the book savior mobile application system of FIG. 1, according to an embodiment of the present disclosure.

FIG. 9 is a screen view the book savior mobile application system of FIG. 1, according to an embodiment of the present disclosure.

FIG. 10 is a screen view the book savior mobile application system of FIG. 1, according to an embodiment of the present disclosure.

FIG. 11 is a screen view the book savior mobile application system of FIG. 1, according to an embodiment of the present disclosure.

FIG. 12 is a screen view the book savior mobile application system of FIG. 1, according to an embodiment of the present disclosure.

FIG. 13 is a screen view the book savior mobile application system of FIG. 1, according to an embodiment of the present disclosure.

FIG. 14 is a screen view the book savior mobile application system of FIG. 1, according to an embodiment of the present disclosure.

FIG. 15 is a screen view the book savior mobile application system of FIG. 1, according to an embodiment of the present disclosure.

FIG. 16 is a screen view the book savior mobile application system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mobile application and more particularly to a book savior mobile application systems and method as used to improve access to used books and facilitating exchanges.

Generally, the present invention is directed to a book savior mobile application system which may generally comprise a software application useful for connecting users for exchanging textbooks.

In one embodiment of the present invention, the book savior mobile application system may comprise a mobile software application and network comprising a user registration system, a navigable website and homepage, a textbook search function, a user-interactive personal message system, a secure payment checkout system, a barcode/logo scanner function, a user profile, a stock page, a sell page, a GPS locator.

The book savior mobile application may allow users to access the above systems on a mobile device and connects all users in a universal network allowing individuals to exchange textbooks. Each function of the mobile application program may be accessible through a navigable homepage on a mobile device (such as a smartphone, tablet, or the like). The combined functionality of the mobile application software effectively provides an online marketplace for exchanging books.

A user may register a user account within a network of the book savior mobile application system, and may be able to access a network homepage. The user may be required to provide a student ID number and a credit or debit card in order to participate in online transactions. From the homepage, a user may choose to search for a textbook, list a textbook for lease, create a course material list, or access course material lists based on the user's registration credentials. Users may search based on title, author, ISBN, barcode, and course reference.

Students may access courses associated with their student ID, and interact with associated professors. The book savior mobile application may be installed to a mobile device through an “app store” and accessed through the device. The network may be connected to using an established internet connection used by the mobile device. The described functionalities are usable through the software and hardware integral to the mobile device, such as microphones, cameras, touchscreens, GPS modules, and other components.

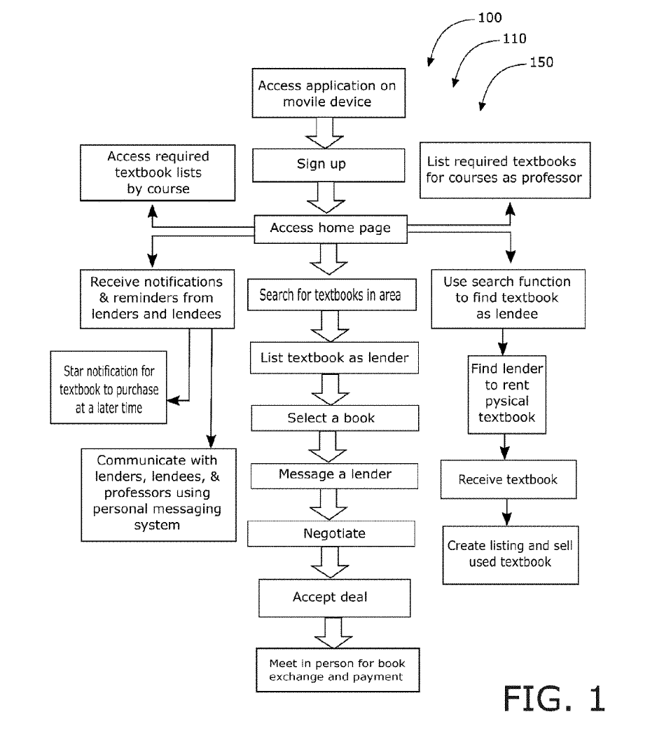

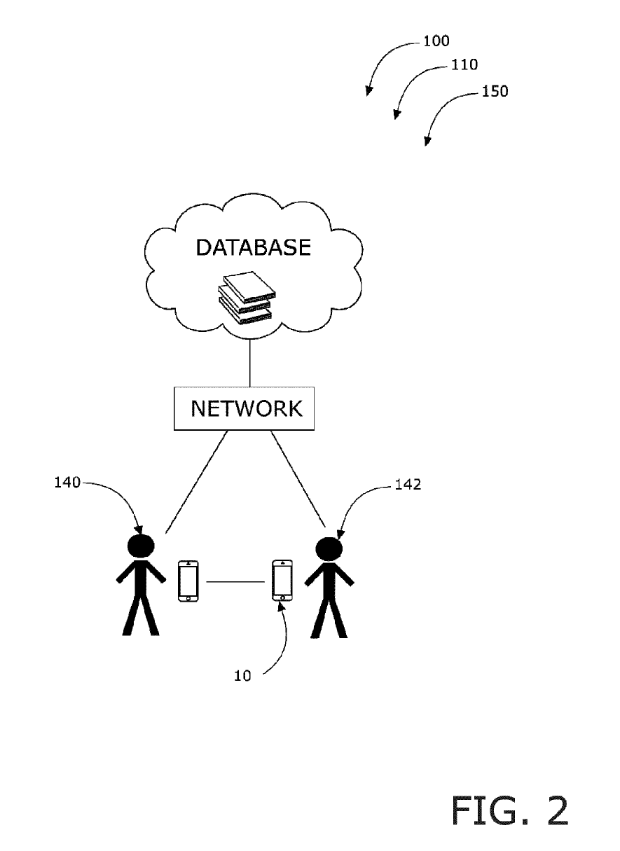

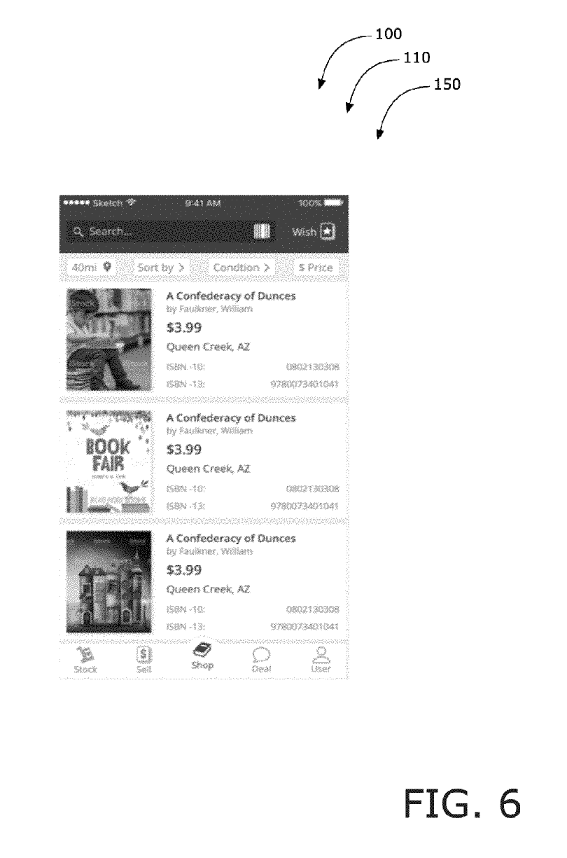

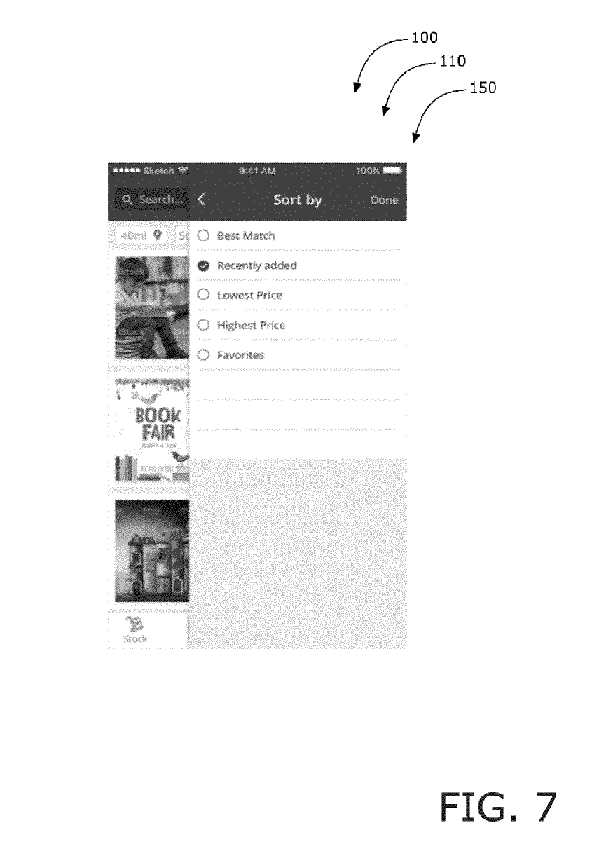

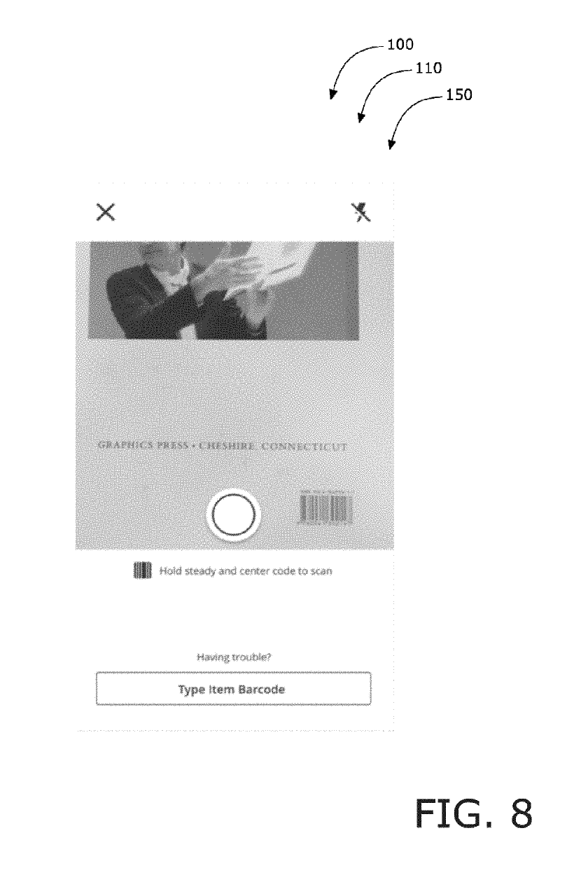

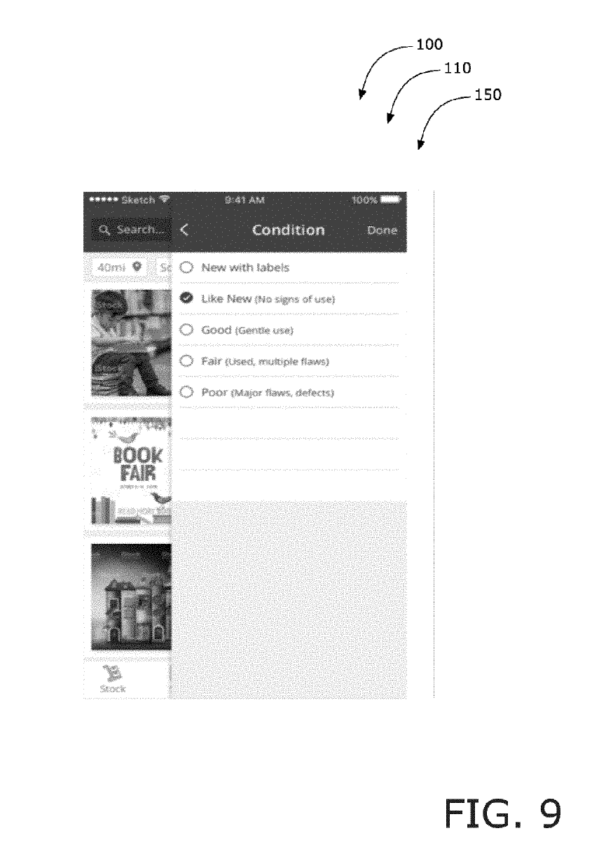

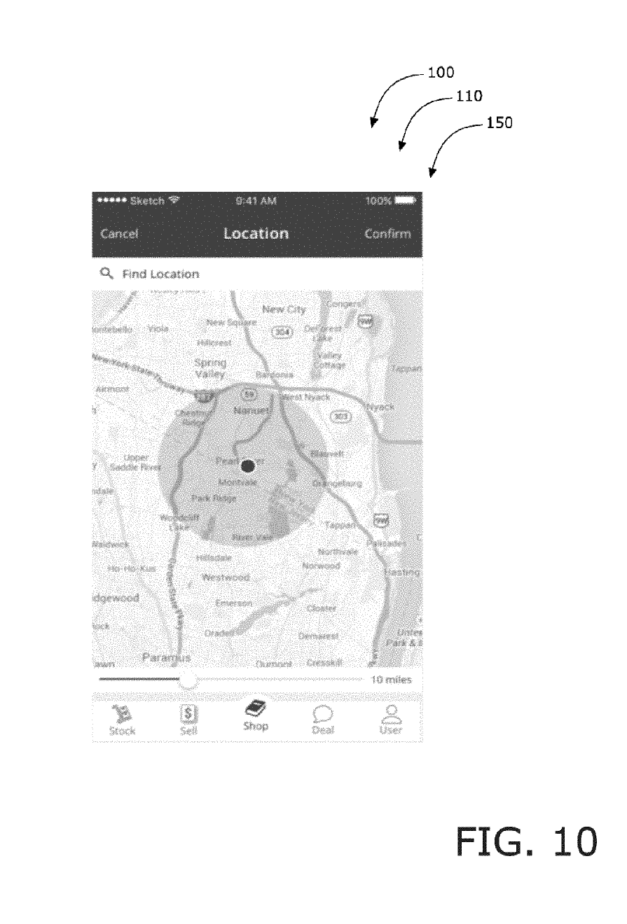

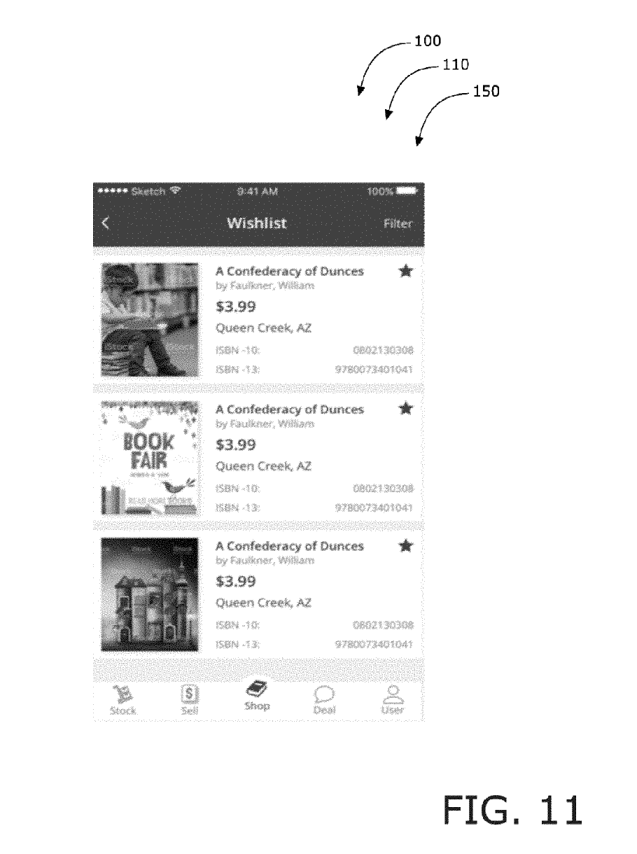

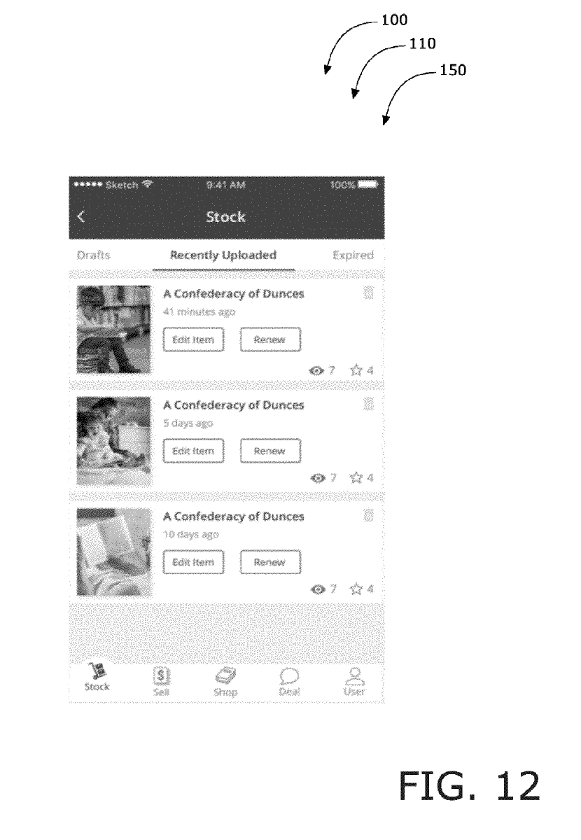

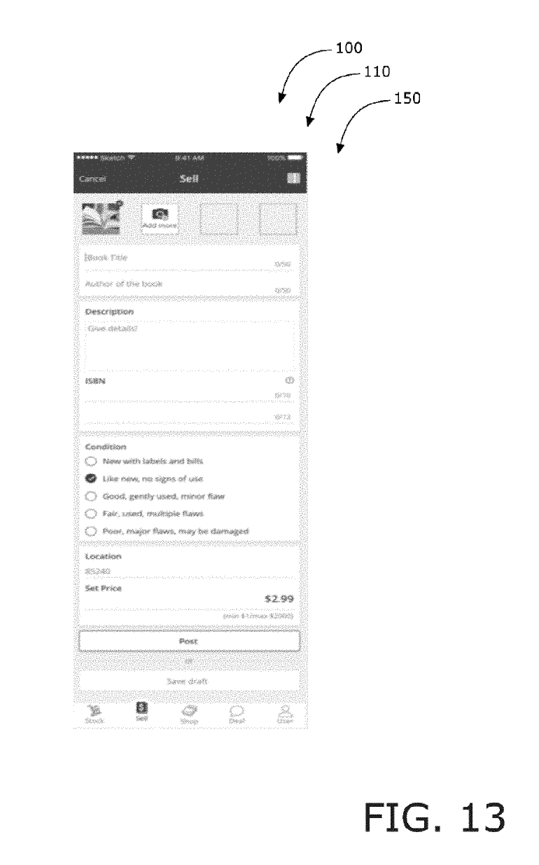

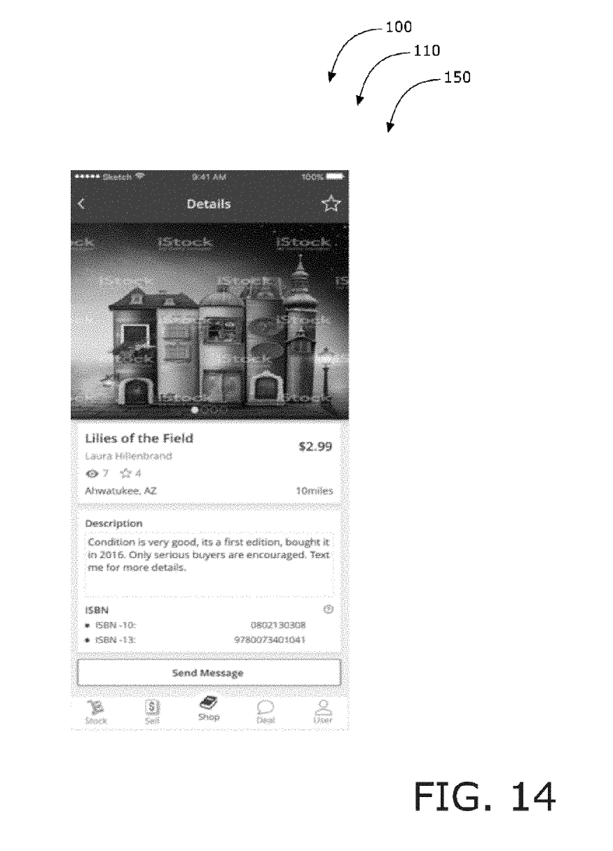

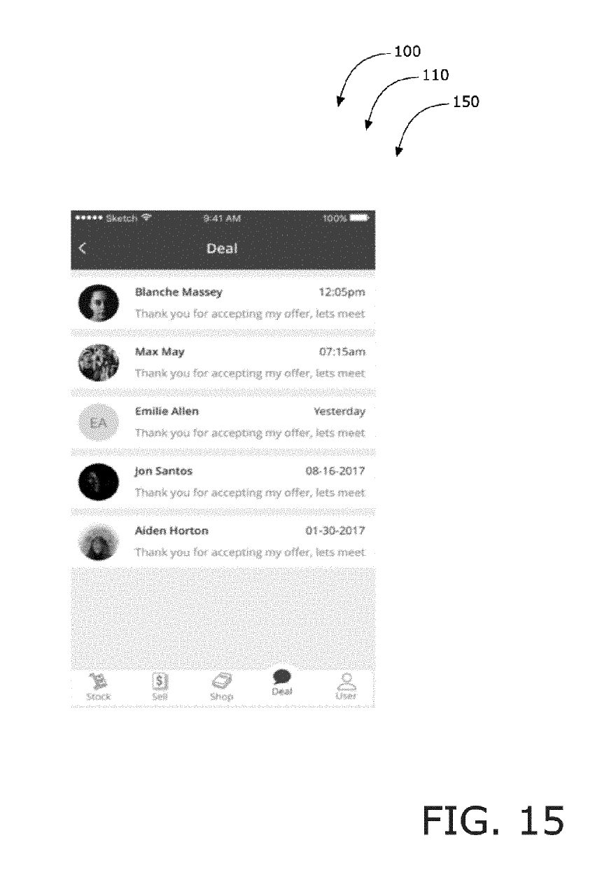

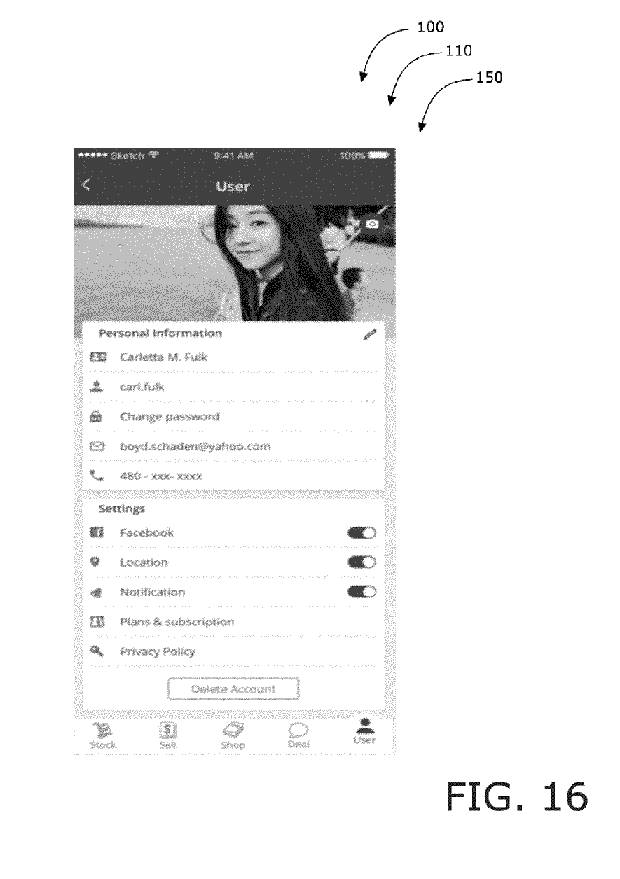

Referring now more specifically to the drawings by numerals of reference, there is shown in FIGS. 1-16, various views of a book savior mobile application system 100 and method. FIG. 1 shows a book savior mobile application system 100 during an ‘in-use’ condition 150, according to an embodiment of the present disclosure. As illustrated, the book savior mobile application system and method 100 may include mobile-application supporting a software of the book savior mobile application system and a mobile device 10 in communication with the mobile-application. The mobile device 10 includes a display, a memory and a processor in functional combination. The book savior mobile application system provides means for a book exchange including at least one user 140 to buy, lend, and sell used-books. The mobile-application is supported on the mobile device 10. The mobile device 10 such as a cell phone or tablet is configured to provide services based on global positioning system allowing for location based searching for used-books. The used-books are searched for in a specified area by barcode, International Standard Book Number, author, title, or associated course. An exchange of the used-book is face-to-face-exchanged.

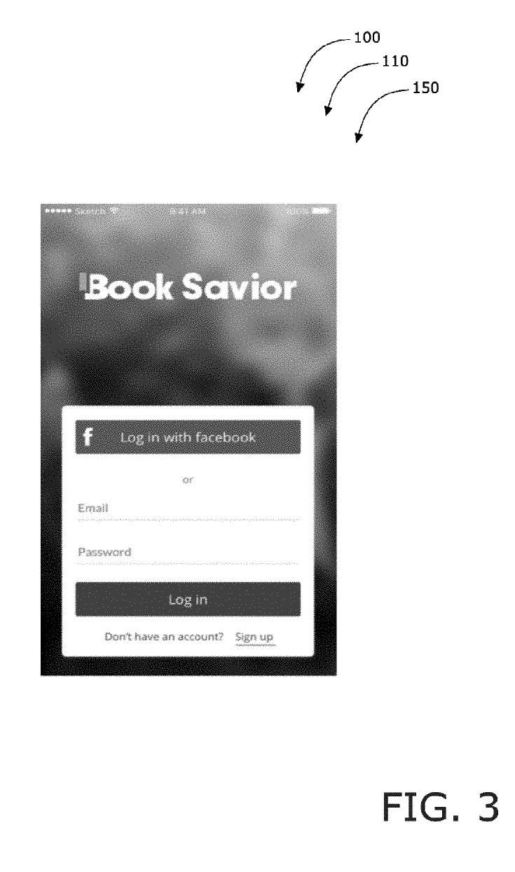

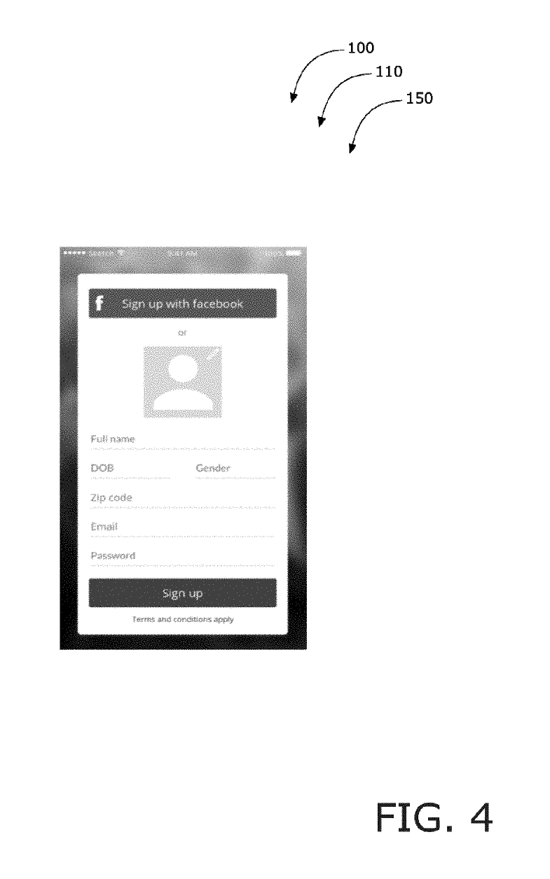

As shown in FIGS. 3-4, a user may register a user account within a network of the book savior mobile application system 100, and may be able to access a network homepage.

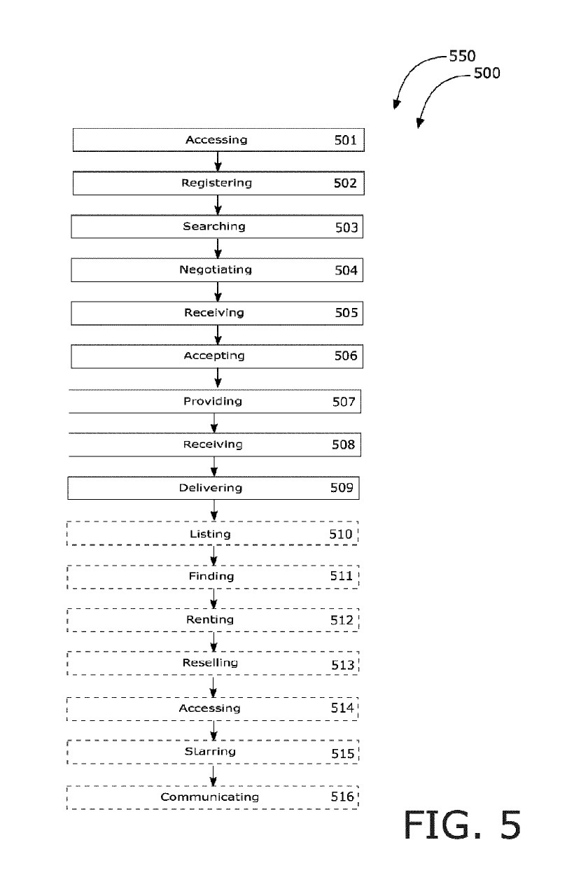

FIG. 5 is a flow diagram 550 illustrating a method of facilitating book exchanges 500, according to an embodiment of the present disclosure. As illustrated, the method of facilitating book exchanges 500 may include the steps of: step one 501, a user 140 accessing a book savior mobile application on a mobile device 10; step two 502, registering as the user 140; step three 503, searching for a used-book in a specified area; step four 504, negotiating with a lender 142 of the used-book; step five 505, the lender 142 receiving a request to purchase the used-book; step six 506, the lender 142 accepting an offer from the user 140; step seven 507, the user 140 making a payment; step eight 508, the lender 142 receiving payment; and step nine 509, the lender 142 delivering the used-book.

The method further comprises the steps of: step ten 510, listing a required the used-book for a course; step eleven 511, finding a lender 142 to rent the used-book; step twelve 512, renting the used-book; step thirteen 513, reselling the used-book after use; step fourteen 514, accessing textbook lists by the course; step fifteen 515, starring the used-book for purchase at a later time; and step sixteen 516, communicating between lenders 142, lendees, and professors.

It should be noted that step ten 510, step eleven 511, step twelve 512, step thirteen 513, step fourteen 514, step fifteen 515, and step sixteen 516 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of facilitating book exchanges 500 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of facilitating book exchanges on a book savior mobile application system, said method comprising the steps of:
a user accessing a book savior mobile application on a mobile device;
registering as said user;
searching for a used-book in a specified area;
negotiating with a lender of said used-book;
said lender receiving a request to purchase said used-book;
said lender accepting an offer from said user;
said user making a payment;
said receiving payment; and
said lender delivering said used-book.

2. The method of facilitating book exchanges on a book savior mobile application system of claim 1, said method further comprising the step of: listing a required said used-book for a course.

3. The method of facilitating book exchanges on a book savior mobile application system of claim 1, said method further comprising the step of: finding a lender to rent said used-book.

4. The method of facilitating book exchanges on a book savior mobile application system of claim 1, said method further comprising the step of: renting said used-book.

5. The method of facilitating book exchanges on a book savior mobile application system of claim 1, said method further comprising the step of: reselling said used-book after use.

6. The method of facilitating book exchanges on a book savior mobile application system of claim 1, said method further comprising the step of: accessing textbook lists by said course.

7. The method of facilitating book exchanges on a book savior mobile application system of claim 1, said method further comprising the step of: starring said used-book for purchase at a later time.

8. The method of facilitating book exchanges on a book savior mobile application system of claim 1, said method further comprising the step of: communicating between lenders, lendees, and professors.

9. A book savior mobile application system, said system comprising:
a mobile-application supporting a software of said book savior mobile application system;
a mobile device in communication with said mobile-application;
wherein said mobile device includes a display, a memory and a processor in functional combination;
wherein said book savior mobile application system provides means for a book exchange including at least one user to buy, lend, and sell used-books; and
wherein said mobile-application is supported on said mobile device.

10. The book savior mobile application system and method of claim 9, wherein said mobile device is configured to provide services based on global positioning system.

11. The book savior mobile application system and method of claim 10, wherein said book savior mobile application system is location based using said global positioning system.

12. The book savior mobile application system and method of claim 10, wherein said used-books are searched for in a specified area.

13. The book savior mobile application system and method of claim 9, wherein said used-books are searched for by barcode.

14. The book savior mobile application system and method of claim 9, wherein said used-books are searched for by International Standard Book Number.

15. The book savior mobile application system and method of claim 9, wherein said used-books are searched for by author.

16. The book savior mobile application system and method of claim 9, wherein said used-books are searched for by title.

17. The book savior mobile application system and method of claim 9, wherein said used-books are searched for by associated course.

18. The book savior mobile application system and method of claim 9, wherein an exchange of said used-book is face-to-face-exchanged.

19. The book savior mobile application system and method of claim 9, wherein said mobile device includes a cell phone.

20. A method of facilitating book exchanges on a book savior mobile application system, said method comprising the steps of:
a user accessing a book savior mobile application on a mobile device;
registering as said user;
said user searching for a used-book in a specified area;
said user accessing textbook lists by said course
said lender listing a required said used-book for a course;
said user finding a lender to rent said used-book;
negotiating with a lender of said used-book;
said lender receiving a request to purchase said used-book;
said lender accepting an offer from said user;
said user making a payment;
said lender receiving payment;
said lender renting said used-book;
said lender delivering said used-book; and
said user reselling said used-book after use.
